(19) United States
(12) Patent Application Publication
(10) Pub. No.: US 2015/0212785 A1
(43) Pub. Date: Jul. 30, 2015

(54) EXTENSION DEVICE AND EXTENSION METHOD

(71) Applicant: Kabushiki Kaisha Toshiba, Tokyo (JP)

(72) Inventors: Hiroaki CHIBA, Sagamihara Kanagawa (JP); Takehiro HORI, Tokyo (JP)

(21) Appl. No.: 14/600,271

(22) Filed: Jan. 20, 2015

Related U.S. Application Data
(60) Provisional application No. 61/932,107, filed on Jan. 27, 2014.

(51) Int. Cl. G06F 3/14; G09G 5/00; G09G 5/12; G06F 1/16

(52) U.S. Cl. CPC G06F 3/1431; G06F 1/1632; G09G 5/006; G09G 5/12; G09G 2370/22; G09G 2360/02; G09G 2360/04

(57) ABSTRACT

A display output extension device for an electronic device, the display output extension device comprising: a first connector capable of connecting to a first monitor; a first output controller to separate a first display signal from a display output and to output the first display signal to the first connector; a monitor to monitor an HPD signal from the first connector; and a controller to suppress an initialization of the first monitor when the HPD signal shows a continuously connected state of the first monitor.

### CROSS-REFERENCE TO RELATED APPLICATION(S)

This application claims priority from U.S. Provisional Patent Application No. 61/932,107 filed on Jan. 27, 2014, the entire contents of which are incorporated herein by reference.

### TECHNICAL FIELD

An exemplary embodiment of the present invention relates to an extension device and an extension method of an electronic device.

### BACKGROUND ART

There is a function called a Multi-Stream Transport (refer it to as an MST, hereinafter) that is defined by VESA (a trademark, Video Electronics Standards Association) DisplayPort (a trademark, refer it to as a DP, hereinafter) v1.2 (Version 1, Revision 2a etc.).

This is the function that outputs a plurality of single streams together from one Source device (ex: GPU) and displays the individual Single streams by a plurality of Sink devices (ex: DP monitor). Recently, a Hub IC corresponding to the MST is developed.

For instance, a display signal connection example of a Docker (an extension device) side in a note PC according to a usual technique is a connection example in which a GPU has two output Ports for external display devices mounted and two screens can be displayed at the same time.

However, as a problem, DP signals for the two Ports (two sets of 1 Port) from the GPU need to be connected to the Docker side.

As a new technique, a display signal connection which uses the above-described MST Hub IC is anticipated to be common in future. Because, problems of the usual technique can be solved and below-described advantages can be obtained.

(1) The DP signal of one Port may be necessary which passes the Docker (which contributes to the miniaturization of a connector).
(2) A switch is not necessary, so that an attenuation of a signal is reduced.
(3) Three screens can be displayed at the same time.

However, a disadvantage (a problem) of the new technique resides in that the MST Hub IC needs more time from recognition of a monitor to a display than the usual technique. Because, in the MST Hub IC, processes of below-described (1) to (4) are generated.

(1) A recognition and initialization (a communication and a link) of a first DP monitor by the MST Hub IC.
(2) A recognition and initialization (a communication and a link) of a second DP monitor by the MST Hub IC (the same as described above).
(3) A recognition and initialization of the MST Hub IC by the GPU.
(4) The GPU outputs a video signal by the MST.

### BRIEF DESCRIPTION OF THE DRAWINGS

FIG. 1 is an entire perspective view showing one structure example of an extension device according to an exemplary embodiment and a note PC as an electronic device connected to the extension device.

FIG. 2 is a block diagram which schematically shows an inner structure example of the extension device and the note PC shown in FIG. 1.

FIGS. 3A and 3B are explanatory views of one example of an operation of a signal converting part when a connection of an RGB socket is most preferred.

FIG. 4 is a block diagram showing a connection example of a display signal using an MST Hub IC of the exemplary embodiment.

FIG. 5 is a block diagram showing a connection example of a display signal of the note PC having a Docker used the exemplary embodiment.

FIG. 6 is a flowchart showing processes of the exemplary embodiment.

### MODE FOR CARRYING OUT THE INVENTION

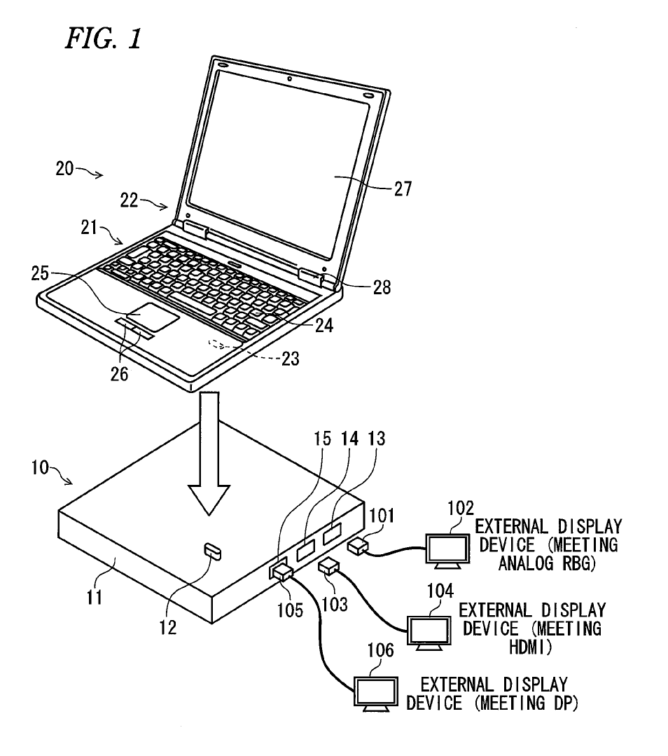

Now, referring to FIG. 1 to FIG. 6, an exemplary embodiment will be described below.

An extension device (Docker as a popular name) according to the present exemplary embodiment is an extension device which extends functions of an electronic device and has video output terminals according to a plurality of standards to reduce the number of signal lines of video signals electrically connected to the electronic device through a connecting terminal. The signal lines have the number according to a prescribed video signal standard. In a below-described explanation, as the electronic device connected to the extension device according to the present exemplary embodiment, an example is shown in which a notebook type personal computer (refer it to as a note PC, hereinafter) is used. The electronic device as an information processor which has a video signal output function and is connected to the extension device as an external unit is not limited to the note PC, for instance, a PDA (Persona Digital Assistant), a portable game machine, a portable music reproducing device, a portable moving image reproducing device, or the like may be used.

### (1) Structure of Model of Hardware

FIG. 1 is an entire perspective view showing one structure example of an extension device 10 according to a first exemplary embodiment and a note PC 20 as an electronic device connected to the extension device 10.

The extension device 10 is a device having functions to be extended to ensure a portability of the note PC 20 and extend functions usable by a user, and includes a base part 11 which incorporates various kinds of circuits and an extension side connecting terminal 12 electrically connected to the note PC 20. Further, in the present exemplary embodiment, as shown in FIG. 1, an example is explained that the extension device 10 includes a video output terminal (an RGB socket, a connector) 13 according to an analog RGB standard standardized by a VESA (a Video Electronics Standards Association), an HDMI socket (a connector) 14 according to an HDMI (a High-Definition Multimedia Interface) standard and a video output terminal (a DP socket, a connector) 15 according to a DisplayPort standard (a DP standard).

Another set of DP socket may be provided and a DVI socket may be further provided (not shown in the drawing due to complicatedness).

To the RGB socket 13, an RGB plug 101 is connected. The RGB socket 13 outputs a video signal according to the analog RGB standard to an external display device 102 (a monitor display) connected to the RGB plug 101 which meets the analog RBG standard through the RGB plug 101.

To the HDMI socket 14, an HDMI plug 103 is connected. The HDMI socket 14 outputs a video signal according to the HDMI standard to an external display device 104 connected to the HDMI plug 103 which meets the HDMI standard through the HDMI plug 103. Further, to the DP socket 15, a DP plug 105 is connected. The DP socket 15 outputs a video signal according to the DP standard to an external display device 106 connected to the DP plug 105 which meets the DP standard through the DP plug 105.

The note PC 20 includes a computer main body 21 and a display unit 22 as a display device. The computer main body 21 has a thin box shaped casing. On a bottom surface of the casing, a PC side connecting terminal 23 is provided which can be electrically connected to the extension side connecting terminal 12 of the extension device 10. In the extension side connecting terminal 12 and the PC side connecting terminal 23, for instance, one of them has a form protruding with a prescribed length from one of the casings of the extension device 10 and the note PC 20, and the other has a recessed form which is fitted to one of the extension side connecting terminal 12 and the PC side connecting terminal 23.

Further, on a central part of an upper surface of the casing of the computer main body 21, a keyboard 24 is provided as an operating part. In a front side of the upper surface of the casing, a palm rest is formed. In a substantially central part of the palm rest, a touch pad 25 and a touch button 26 are provided as the operating part. On the other hand, the display unit 22 has a display panel 27 and is connected and supported to the computer main body 21 so as to be freely opened and closed through a connecting part (a hinge) 28.

The operating part (the key board 24, the touch pad 25, the touch button 26) supplies an operation input signal corresponding to an operation of the user to a main control part 32 (not shown in the drawing) in the computer main body 21 of the note PC. The display panel 27 is formed with an ordinary display and output device such as a liquid crystal display, an OLED (an Organic Light Emitting Diode) display, a light emitting diode, or the like and displays various kinds of information in accordance with a control of the main control part 32.

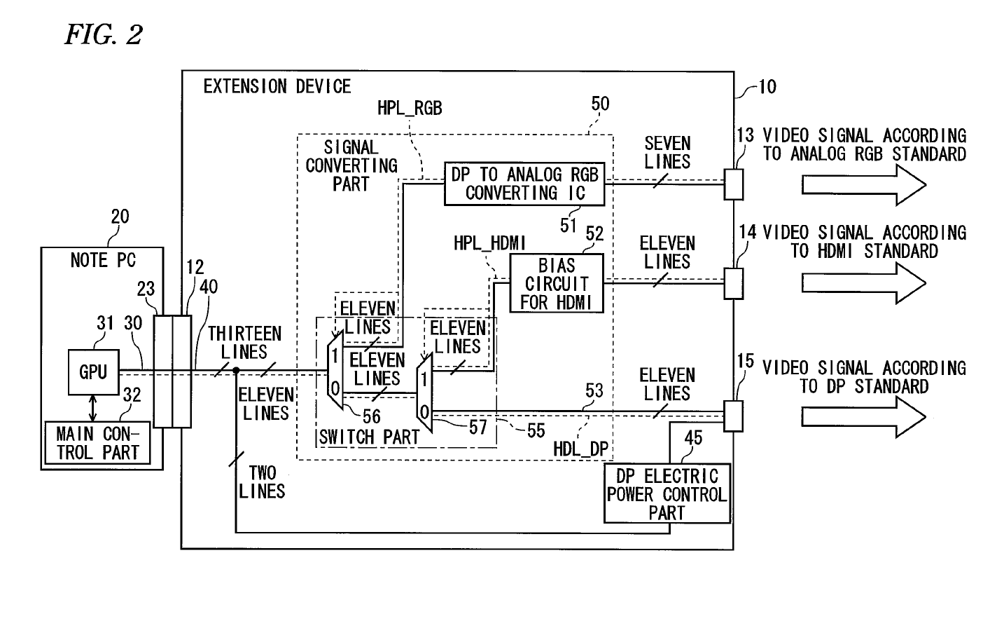

FIG. 2 is a block diagram which schematically shows an inner structure example of the extension device 10 and the note PC 20 shown in FIG. 1.

As shown in FIG. 2, the note PC 20 further includes a signal line 30 having at least the number according to a prescribed video signal standard, a GPU 31 (a Graphics Processing Unit) as a graphics controller having an image processing function and a main control part 32. The GPU 31 is controlled by the main control part 32 to output a video signal according to the prescribed video signal standard to the extension device 10 through the signal line 30 and the PC side connecting terminal 23 to which the signal line 30 is connected. The main control part 32 is formed with a storing medium such as a CPU, a RAM and a ROM to control an operation of the note PC 20 in accordance with a program stored in the storing medium.

On the other hand, the extension device 10 further includes a signal line 40 having the number according to the prescribed video signal standard which is connected to the extension side connecting terminal 12, a DP electric power control part 45 and a signal converting part 50.

The signal line 40 is electrically connected to the signal line 30 through the PC side connecting terminal 23 to supply the output of the video signal of the GPU 31 to the signal converting part 50.

To the signal converting part 50, the video signal according to the prescribed video signal standard is inputted from the GPU 31 through the signal line 30, the PC side connecting terminal 23, the extension side connecting terminal 12 and the signal line 40.

The signal converting part 50 converts the video signal according to the prescribed video signal standard which is inputted from the GPU 31 through the signal line 40 into video signals respectively according to the video signal standards of the video output terminals provided in the extension device 10 and outputs the video signals respectively to the corresponding video output terminals.

For instance, when the extension device 10 has the video output terminals according to a first standard and a second standard and the GPU 31 outputs the video signal according to a third standard, if the video signal according to the third standard is inputted to the signal converting part 50, the signal converting part converts the video signal according to the third standard into a video signal according to the first standard and outputs the video signal to the video output terminal according to the first standard. Further, the signal converting part 50 converts the inputted video signal according to the third standard into a video signal according to the second standard and outputs the video signal to the video output terminal according to the second standard.

Further, when the standards of the video output terminals are the same as the standard of the video signal of the GPU 31, the signal converting part 50 outputs the inputted video signal by the same standard. This is equal to a fact that the signal converting part 50 does not convert the video signal and directly outputs the inputted video signal to the video output terminal.

In a below-described explanation, an example will be shown in which the extension device 10 has, as the model, the RGB socket 13, the HDMI socket 14 and the DP socket 15, and the GPU 31 outputs the video signal (a video signal according to the DP standard) according to standards of a physical layer and a logical layer of the DP standard through the signal lines 30 and 40 according to the DP standard or the video signal according to a logical layer of the HDMI standard.

In this case, the signal lines 30 and 40 have at least the number according to the DP standard. Here, the number of the signal lines 30 and 40 based on the DP standard means eleven in total which includes ten signal lines for transmitting differential signals (two of which are signal lines (side bands) corresponding for transmitting DDC (VESA Display Data Channel) signals of the HDMI standard) and one signal line for transmitting a hot plug signal.

In the present exemplary embodiment, an example will be described in which the signal lines 30 and 40 further include two signal lines for controlling an electric power by which the GPU 31 supplies an instruction to the DP electric power control part 45. Accordingly, the signal lines 30 and 40 have the number of thirteen in total.

The number based on the analog RGB standard is seven in total including three signal lines for transmitting RGB signals respectively, two Sync signal lines and two DDC signal limes. Further, the number based on the HDMI standard is eleven in total which includes eight signals lines for transmitting the differential signals, two signal lines for the DDC and one signal line for transmitting the hot plug signal.

The DP electric power control part 45 is controlled by the GPU 31 through the two signal lines for controlling the electric power to control a supply of an electric power to the DP socket 15.

The signal converting part 50 includes a DP to analog RGB converting IC (an Integrated Circuit) (refer it to as an RGB converting part, hereinafter) 51, a bias circuit for an HDMI (refer it to as an HDMI converting part, hereinafter) 52 and a DP converting part 53. To video signal input sides (the GPU 31 side) of the converting parts 51 to 53 respectively, signal lines respectively based on the same video standards as those of the signal line 30 and the signal line 40 are connected. Further, to video signal output sides (the socket 13 to 15 sides) of the converting parts 51 to 53, signal lines respectively according to the video signal standards of the sockets 13 to 15 are connected.

The RGB converting part (the DP to analog RGB converting IC) 51 converts the video signal according to the DP standard which is outputted from the GPU 31 into a video signal according to the analog RGB standard and outputs the video signal to the RGB socket 13.

Further, the RGB converting part 51 monitors an electric potential outputted by the RGB socket 13. The RGB socket 13 outputs the electric potential of a high level and the electric potential of a low level respectively when the PGB plug 101 is connected thereto and when the RGB plug 101 is not connected thereto. The RGB converting part 51 uses the electric potential outputted by the RGB socket 13 as a connection recognizing signal to generate a signal (an HPL_RGB signal) equivalent to a hot plug signal (an HPL_HDMI signal) outputted by the HDMI socket 14 or a hot plug signal (an HPL_DP signal) outputted by the DP socket 15 and outputs the signal (the HPL_RGB signal) to the signal line of the GPU 31 side.

In other words, the RGB socket 13 is formed so as to output the connection recognizing signal to the signal converting part 50 when the RGB plug 101 is connected thereto. Further, when the HDMI plug 103 and the DP plug 105 are respectively connected to the HDMI socket 14 and the DP socket 15, the HDMI socket 14 and the DP socket 15 output the hot plug signals (connection recognizing signals) to the signal converting part 50. In FIG. 2, signal lines for transmitting the connection recognizing signals are shown by dotted lines for the purpose of an explanation.

The HDMI converting part (the bias circuit for the HDMI) 52 adjusts a bias voltage (information of a physical layer) of the video signal according to the logical layer of the HDMI standard which is outputted by the GPU 31 to convert the video signal into a signal according to a standard of a physical layer of the HDMI standard and output the signal to the HDMI socket 14. As a result, the signal outputted by the HDMI converting part 52 is the video signal based on the standards of the physical layer and the logical layer of the HDMI standard.

Further, the HDMI converting part 52 receives the hot plug signal (the HPL_HDMI signal) outputted by the HDMI socket 14 and directly outputs the hot plug signal to the signal line of the GPU 31 side.

The DP converting part 53 is a member which directly outputs the video signal according to the DP standard which is outputted by the GPU 31 to the DP socket 15 and is formed with a simple wiring (a signal line) according to the DP standard.

Further, the DP converting part 53 receives the hot plug signal (the HPL_DP signal) outputted by the DP socket 15 and directly outputs the hot plug signal to the signal line of the GPU 31 side.

The connection recognizing signals supplied to the signal converting part 50 are supplied to the GPU 31 through the signal line 40, the extension side connecting terminal 12, the PC side connecting terminal 23 and the signal line 30.

In the present exemplary embodiment, an example will be shown in which the signal converting part 50 selectively outputs the video signals to the sockets 13 to 15 respectively. In this case, the signal converting part 50 has a switch part 55.

The switch part 55 has a first multiplexer (a first MUX) 56, and a second multiplexer (a second MUX) 57.

The first MUX 56 supplies the video signal received from the GPU 31 to one of the RGB converting part 51 and the second MUX 57. To the first MUX 56, the HPL_RGB signal converted and outputted by the RGB converting part 51 in accordance with the connection recognizing signal outputted by the RGB socket 13 is supplied as a switch control signal.

The HPL_RGB signal inputted to the first MUX 56 as the switch control signal is supplied to the first MUX 56 as the switch control signal, for instance, through a new one signal line which can be obtained by allowing one signal line to branch into two signal lines for transmitting the hot plug signal included in a signal line which connects the RGB converting part 51 to an output terminal of the first MUX 56.

In FIG. 2, an example is shown that when in the first MUX 56, the HPL_RGB signal shows the high level (see “1” in the first MUX 56 in FIG. 2), the signal line 40 is connected to the RGB converting part 51, and when the HPL_RGB signal shows the low level (see “0” in the first MUX 56 in

FIG. 2), the signal line 40 is connected to the second MUX 57. In a below-described explanation, a case that the connection recognizing signal shows the high level is set to “1” and a case that the connection recognizing signal shows the low level is set to “0”.

The second MUX 57 supplies the video signal received from the first MUX 56 to one of the HDMI converting part 52 and the DP converting part 53. To the second MUX 57, the connection recognizing signal (the HPL HDMI signal) outputted by the HDMI socket 14 is supplied as a switch control signal through the HDMI converting art 52.

The HPL_HDMI signal inputted to the second MUX 57 as the switch control signal is also supplied to the second MUX 57 as the switch control signal, for instance, through a new one signal line which can be obtained by allowing one signal line to branch into two signal lines for transmitting the hot plug signal included in a signal line which connects the HDMI converting part 52 to an output terminal of the second MUX 57.

In FIG. 2, an example is shown that when in the second MUX 57, the HPL HDMI signal shows the high level “1”, the first MUX 56 is connected to the HDMI converting part 52, and when the HPL RGB signal shows “0”, the first MUX 56 is connected to the DP converting part 53.

(2) Operation when Connection of RGB Socket 13 is most Preferred

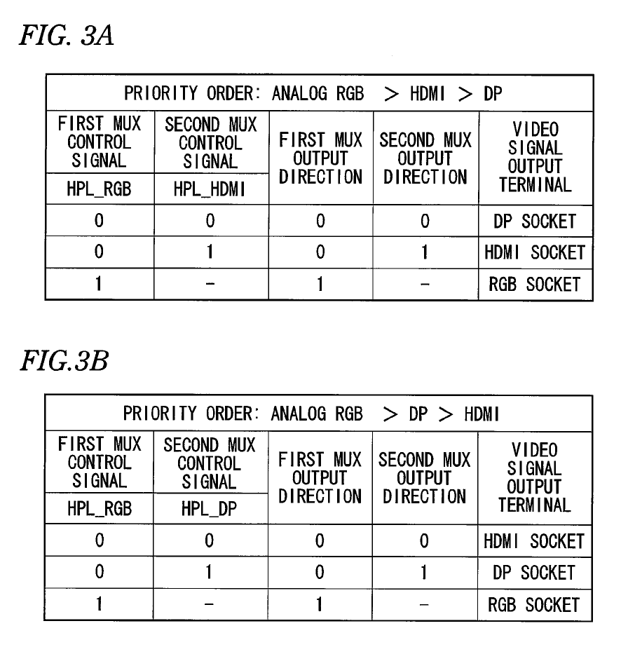

FIGS. 3A and 3B show one example of an operation of the signal converting part 50 when a connection of the RGB socket 13 is most preferred. FIG. 3A is an explanatory view showing one example of an operation of the signal converting part 50 when a connection of the HDMI socket 14 realized by the extension device 10 shown in FIG. 2 is more preferred than a connection of the DP socket 15. FIG. 3B is an explanatory view showing one example of an operation of the signal converting part 50 when a connection of the DP socket 15 is more preferred than a connection of the HDMI socket 14.

(2-1) When Connection of HDMI Socket 14 is More Preferred than Connection of DP Socket 15

As shown in FIG. 2 and FIG. 3A, in the structure shown in FIG. 2, the connection of the RGB socket 13 is most preferred, and the connection of the DHMI socket 14 is more preferred than the connection of the DP socket 15. Specifically, when the RGB plug 101 is connected to the RGB socket 13 and the HPL_RGB signal is inputted to the first MUX 56 (the HPL_RGB signal shows the high level “1”), the video signal received from the GPU 31 is supplied to the RGB converting part 51 irrespective of connecting states of other sockets 14 and 15, converted into the video signal according to the analog RGB standard and outputted to the RGB socket 13.

Further, when the RGB socket 101 is not connected to the RGB socket 13 and the HPL_RGB is not inputted to the first MUX 56 (the HPL_RGB signal shows the low level “0”) and the HDMI plug 103 is connected to the HDMI socket 14 and the HPL_HDMI is inputted to the second MUX 57 (the HPL_HDMI shows the high level “1”, the video signal received form the GPU 31 is supplied to the HDMI converting part 52 irrespective of a connecting state of the DP socket 15, converted into the video signal according to the HDMI standard and outputted to the HDMI socket 14.

For instance, a case that the RGB plug 101 is connected to the RGB socket 13 will be considered. In this case, since the HPL_RGB signal is set to “1”, the first MUX 56 connects the signal line 40 to the RGB converting part 51 irrespective of the connecting states of other sockets 14 and 15. As a result, the signal line 40 is electrically connected to the RGB socket 13. On the other hand, a connection of the signal line 40 to other sockets 14 and 15 is opened.

Therefore, the RGB socket 13 is electrically connected to the GPU 31 of the note PC 20 through the RGB converting part 51 and the first MUX 56. Accordingly, the HPL_RGB signal generated by the RGB converting part 51 in accordance with the connection recognizing signal outputted by the RGB socket 13 is supplied to the GPU 31.

When the GPU 31 receives the HPL_RGB signal, the GPU 31 receives information from the external display device 102 through a DDC signal line that the external device 102 connected to the RGB socket 13 is a display device based on the RGB standard by data of, for instance, an EDID (Extended Display Identification Data) form. Then, the GPU 31 outputs the video signal according to the DP standard through the signal line 30 according to the DP standard. The video signal is supplied to the RGB converting part 51, converted into the video signal according to the analog RGB standard and outputted to the external display device 102 according toe the RGB through the RGB socket 13 and the RGB plug 101.

Further, for instance, a case will be considered that the HDMI plug 103 is connected only to the HDMI socket 14 of the sockets 13 to 15 and the plugs are not connected to other sockets 13 and 15. In this case, the HPL_RGB signal is set to “0” and the HPL_HDMI signal is set to “1”. Therefore, the first MUX 56 connects the signal line 40 to the second MUX 57 and the second MUX 57 connects the first MUX 56 to the HDMI converting part 52.

Accordingly, the HDMI socket 14 is electrically connected to the GPU 31 of the note PC 20 through the HDMI converting part 52, the second MUX 57 and the first MUX 56. Thus, the HPL HDMI signal outputted by the HDMI socket 14 is supplied to the GPU 31. When the GPU 31 receives the HPL HDMI signal, the GPU 31 receives information from the external display device 104 through a DDC signal line that the external device 104 connected to the HDMI socket 14 is a display device based on the HDMI standard by data of, for instance, an EDID (Extended Display Identification Data) form.

Then, the GPU 31 outputs the video signal according to the logical layer of the HDMI standard through the signal line 30 according to the DP standard. The video signal is supplied to the HDMI converting part 52 to adjust the bias voltage (the information of the physical layer), so that the video signal is converted into a video signal according to the standard of the physical layer of the HDMI standard and outputted to the external display device 104 meeting the HDMI through the HDMI socket 14 and the HDMI plug 103.

Further, for instance, a case will be considered that the DP plug 105 is connected only to the DP socket 15 of the sockets 13 to 15 and the plugs are not connected to other sockets 13 and 14. In this case, the HPL RGB signal is set to “0” and the HPL HDMI signal is set to “0”. Accordingly, the first MUX 56 connects the signal line 40 to the second MUX 57 and the second MUX 57 connects the first MUX 56 to the DP converting part 53.

Therefore, the DP socket 15 is electrically connected to the GPU 31 of the note PC 20 through the DP converting part 53, the second MUX 57 and the first MUX 56. Accordingly, the HPL_DP signal outputted by the DP socket 15 is supplied to the GPU 31. When the GPU 31 receives the HPL_DP signal, the GPU 31 receives information from the external display device 106 through a DDC signal line that the external device 106 connected to the DP socket 15 is a display device based on the DP standard by data of, for instance, an EDID (Extended Display Identification Data) form.

Then, the GPU 31 outputs the video signal according to the DP standard through the signal line 30 according to the DP standard. The video signal is supplied to the DP converting part 53, directly supplied to the DP socket 15 and outputted to the external display device 106 according to the DP through the DP socket 15 and the DP plug 105.

(2-2) When Connection of DP Socket 15 is More Preferred than Connection of HDMI Socket 14

As shown in FIG. 3B, in the structure shown in FIG. 2, when the signal inputted to the second MUX 57 as the switch control signal is set to the HPL_DP signal in place of the HPL HDMI signal, the connection of the RGB socket 13 is most preferred and the connection of the DP socket 15 is more preferred than the connection of the HDMI socket 14.

When the signal converting part 50 selectively outputs the video signals to the sockets 13 to 15 respectively, as a priority level of the connections of the sockets 13 to 15, an arbitrary priority level can be set in accordance with connecting methods of the switch part 55 to the converting parts 51 to 53 and the switch control signals to the switch part 55 respectively.

For the purpose of comparison, initially, an exemplary embodiment of the usual technique will be described below. A display signal connection example (when a Discrete device such as a DeMUX, a Switch or the like is used) of a Docker side in a note PC will be described.

For instance, in the note PC, there is a connection example in which two screens of a Docker can be displayed at the same time in a GPU on which two output Ports for an external display device are mounted. When DP signals for 2 Ports (1 Port x 2) from the GPU are connected to the Docker side, the Docker side connects the DP for 1 Port to a DeMUX (a de-Multiplexer) and connects an output of the DeMUX to, for instance, a DP connector and an HDMI connector.

Since the output of the DeMUX supplies a signal only to one of them, when a monitor is connected to both the connectors, the monitor higher in its priority level is displayed (an exclusive display). The priority level can be arbitrarily changed by a user.

The other DP for 1 Port is connected to, for instance, a Switch (a Passive Switch) so that an output may be switched to a DP to analog RGB converting IC or the DeMux. An output of the DeMUX is connected to the DP connector and a DVI connector and an output of the DP to analog RGB converting IC is connected to an analog RGB connector.

When two monitors or three monitors are connected to the DP connector, the DVI connector and the analog RGB connector, the monitor higher in its priority level is displayed (an exclusive display). For instance, the priority level can be arbitrarily changed by the user as described above.

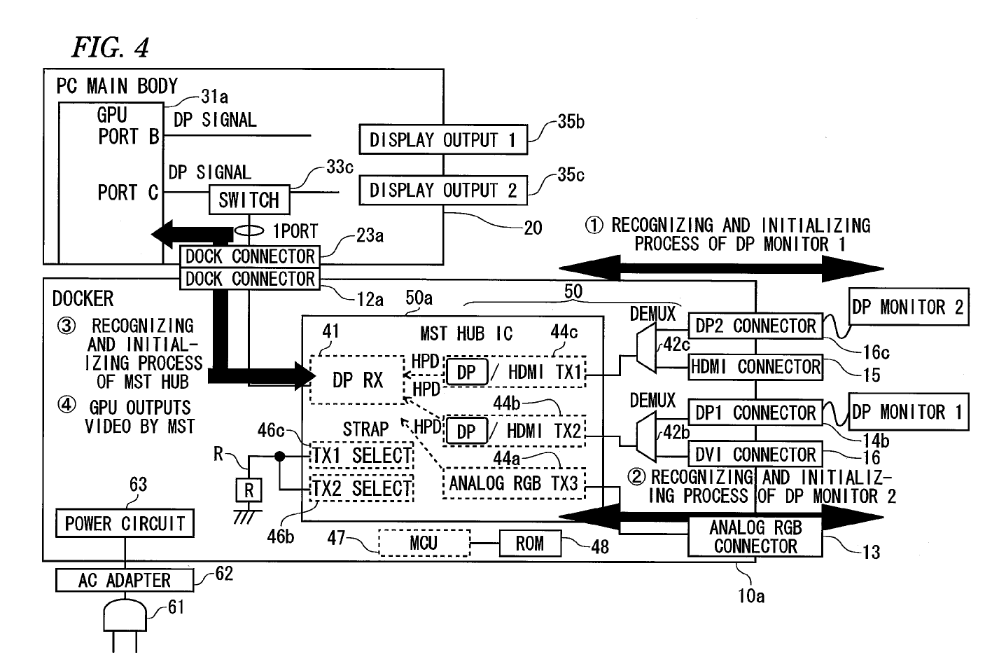

FIG. 4 shows one example of the present exemplary embodiment and a state when a PC is connected to an extension device 10a (refer it to as a Docker 10, hereinafter). Parts whose reference numerals are the same as those of FIG. 1 and FIG. 2 functionally correspond to each other. Typical models as models of the PC include a DP model and an HDMI model. When, for instance, in addition to an Analog RGB connector (for instance, a display output 1 35b), another connector for an external display device (for instance, a display output 2 35c) is provided in the PC, the former has a DP connector and the latter has an HDMI connector.

Now, a structure of the exemplary embodiment will be described below. Firstly, FIG. 4 is a block diagram showing a connection example of a display signal using an MST Hub IC 50a of the exemplary embodiment.

Here, a DP signal for 1 Port (a Port C) from a GPU 31a is connected to the Docker 10 side via a Switch 33c and Dock connectors 23a and 12a. The DP signal (MST) and an output TX1 of the MST Hub IC 50a are connected to a DP connector 16c and an HDMI connector 15 through a DPRX 41 and a DeMUX 42c. An output TX2 of the MST Hub IC 50a is connected to a DP connector 14b and a DVI connector 16 through a DeMUX 42b. An output TX3 of the MST Hub IC 50a is directly connected to an analog RGB connector 13. A TX1 selec 46c and a TX2 selec 46b are set so as to select the DP signal in a selector 44c and a selector 44b by a strap using a resistance R. This setting can be carried out by a GPIO or a BIOS as well as such an HW strap.

The MUST hub (the Docker 10) incorporates an MCU 47 to recognize and initialize a monitor.

As shown in FIG. 4, when the two DP monitors are connected, processes are carried out in below-described order so as to carry out a display operation.

(1) The first DP monitor is recognized and initialized by the MST Hub IC 50a.
(2) The second DP monitor is recognized and initialized by the MST Hub IC 50a.
(3) The MST Hub IC 50a is recognized and initialized by the GPU 31a.
(4) The GPU 31a outputs a video signal by the MST.

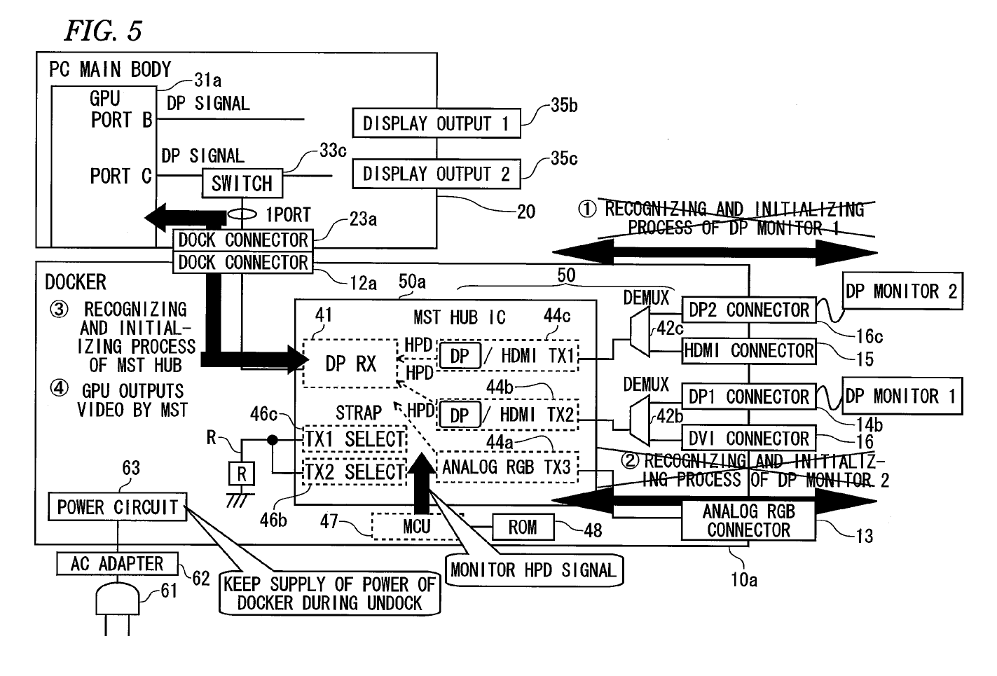

FIG. 5 is a block diagram showing a connection example of a display signal of the note PC having the Docker used in the exemplary embodiment. A characteristic operation will be described on the basis of a connection form in FIG. 4.

FIG. 5 shows a solution which solves a problem when the MST Hub IC 50a is used. A difference from FIG. 4 resides in a control algorithm of an MCU 47 in the MST Hub IC 50a. The control algorithm is shown as described below.

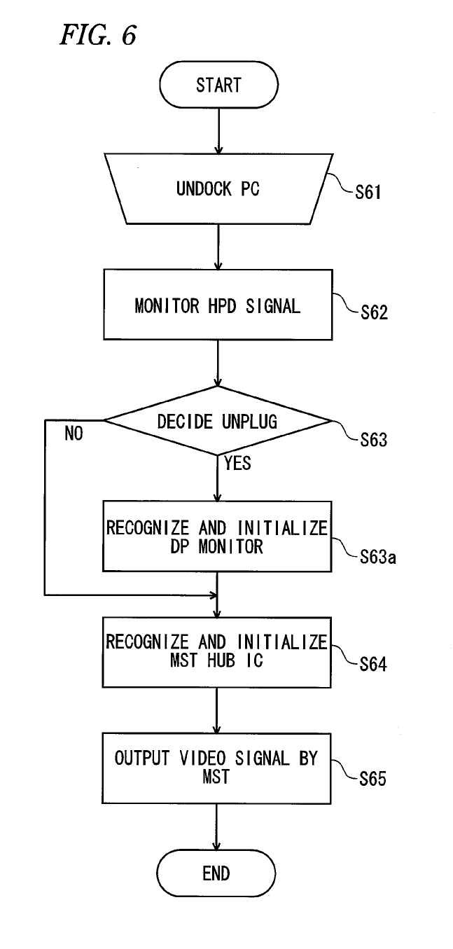

Namely, FIG. 6 is a flowchart showing processes of the exemplary embodiment.

Step S61: A user Undocks the note PC. A power source of the Docker is maintained under a state that it is turned on.
Step S62: The MCU 47 in the MST HUB IC 50a monitors whether or not an HDP signal of a monitor connected to the Docker is Unplugged.
Step S63: When the note PC is Docked, if Unplug of the monitor is not detected, a monitor recognizing and initializing process of the MST Hub IC is omitted (functions as a control unit for suppressing an initialization of the monitor and skips to step S64).
Step 63a: When the Unplug of the monitor is detected in the step S63, the monitor recognizing and initializing process is carried out.
Step S64: A recognizing and initializing process of the MST Hub IC is carried out by a GPU.
Step S65: The GPU outputs a video signal.

In the above explanation, below-described matters are mentioned.

Initially, when the note PC is Undocked, the HPD signal of the monitor connected to the Docker is monitored by the MCU in the MST HUB IC. After that, when the note PC is Docked, if the Unplugged state of the monitor is not detected, the monitor recognizing and initializing process of the MST Hub IC is omitted. Thus, in the Docker for the note PC using the MST Hub IC, a time can be shortened until a display is shown in the Docker side monitor after the note PC is Docked.

Ordinarily, the Docker is placed on a desk and the monitor which is once connected thereto is basically used so as not to be frequently pulled out and in. On the other hand, the note PC is frequently Undocked/Docked. The present exemplary embodiment is effective in such a mode of use.

### SUMMARY

In the present exemplary embodiment, is described a control method of a display signal in the Docker for the note PC using the MST Hub IC. In order to solve the previous problems, below-described measures a to c are made that “when the note PC is Undocked, a hot plug signal (the HPD signal) of the monitor connected to the Docker is monitored by the MCU in the MST HUB IC”.

(a) When the note PC is Undocked, the HPD signal of the monitor connected to the Docker is monitored by the MCU in the MST HUB IC.
(b) When the note PC is Docked, if the Unplugged state of the monitor is not detected, the monitor recognizing and initializing process of the MST Hub IC is omitted.
(c) In order to monitor the HPD signal of the monitor by the MST Hub IC, the power source of the Docker is kept turned ON while the PC is Undocked.

The present invention is not limited to the above-described exemplary embodiment and various modifications may be additionally made within a range which does not depart form its gist.

Further, when a plurality of component elements disclosed in the above-described exemplary embodiment is suitably combined together, various inventions may be devised. For instance, some of the component elements of all the component elements shown in the exemplary embodiment may be deleted. Further, component elements of different exemplary embodiments may be suitably combined together.

1. A display output extension device for an electronic device, the display output extension device comprising:
a first connector capable of connecting to a first monitor;
a first output controller to separate a first display signal from a display output and to output the first display signal to the first connector;
a monitor to monitor an HPD signal from the first connector; and
a controller to suppress an initialization of the first monitor when the HPD signal shows a continuously connected state of the first monitor.

2. The display output extension device according to claim 1, further comprising:
a second connector to to connect to a second monitor; and
a second output controller to separate a second display signal from the display output and to output the second display signal to the second connector, wherein the monitor monitors a second HPD signal from the second connector and the controller suppresses an initialization of the second monitor when the second HPD signal shows a continuously connected state of the second monitor.

3. The display output extension device according to claim 1, wherein the display output is based on a Multi-Stream Transport.

4. The display output extension device according to claim 1, wherein the first display signal is a Single stream based on a DisplayPort.

5. An extension method in a display output extension device of an electronic device, the extension method comprising:
separating a first display signal from a display output and outputting the first display signal to a first connector;
monitoring an HPD signal from the first connector; and
suppressing an initialization of a first monitor when the HPD signal shows a continuously connected state of the first monitor.

6. An extension device according to claim 2, wherein the display output is based on a Multi-Stream Transport.
